(19) United States
(12) Patent Application Publication
(10) Pub. No.: US 2019/0026700 A1
(43) Pub. Date: Jan. 24, 2019

(54) RESOLVING ROOM CONTENTION FOR A MULTI-ENDPOINT MEETING

(71) Applicant: Cisco Technology, Inc., San Jose, CA (US)

(72) Inventors: Jay Kemper Johnston, Raleigh, NC (US); Magnus Mortensen, Cary, NC (US); David C. White, JR., St. Petersburg, FL (US)

(21) Appl. No.: 15/654,791

(22) Filed: Jul. 20, 2017

(51) Int. Cl. G06Q 10/10; H04N 7/15; G06Q 10/06

(52) U.S. Cl. CPC G06Q 10/109; G06Q 10/06314; H04N 7/15

(57) ABSTRACT

The present technology is a videoconference system for addressing room contention for a multi-endpoint meeting. The videoconference system includes a videoconference server that hosts a multi-endpoint meeting amongst local endpoints and remote endpoints, and a wallplate located outside of a physical room that includes a local endpoint. The wallplate receives input and transmits a room contention state indicator. The local endpoint receives the room contention state indicator and sends a room contention signal to the videoconference server, where the videoconference server transmits a room contention message to the remote endpoint.

### TECHNICAL FIELD

The present disclosure relates generally to a conferencing system including at least one wallplate communicatively coupled to a conference room endpoint.

### BACKGROUND

Multi-endpoint conferencing allows participants from multiple locations to collaborate in a meeting. For example, participants from multiple geographic locations can join a meeting and communicate with each other to discuss issues, share ideas, etc. These collaborative meetings often include a videoconference system with two-way audio-video transmissions. Thus, virtual meetings using a videoconference system can simulate in-person interactions between people.

But even though videoconference systems can simulate in-person interactions, some non-verbal communication is still left out. For example, some aspects of a conference participant's environment are important to be communicated to all members of a meeting. If all members of the meeting were present in the same location, the environmental aspects would be communicated to all members of the meeting, but in a videoconference members of the meeting not in a particular room are unaware of environmental factors that are important to the meeting.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 is a conceptual block diagram illustrating an example environment for a videoconference system providing multi-endpoint immersive meeting capabilities, in accordance with various embodiments of the subject technology;

FIG. 2 is an illustration of a wallplate, videoconference server, and local endpoint used together in a multi-endpoint meeting interaction, in accordance with various embodiments;

FIG. 3 is a flowchart illustrating an exemplary method for determining room contention and displaying room contention messages;

FIG. 4 shows an example wallplate display;

FIG. 5A shows an example videoconference room display, including a room contention message;

FIG. 5B shows an example videoconference room display when a meeting extension has been granted; and

FIG. 6 shows an example possible system embodiment.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview:

A system, method, and computer readable storage medium is disclosed for addressing room contention for a multi-endpoint meeting in a videoconference system. In one aspect, a videoconference server hosts a multi-endpoint meeting amongst a local endpoint and one or more remote endpoints. The videoconference server receives a room contention indicator from a wallplate located outside of a physical room that includes the local endpoint. The wallplate is configured to display an in-room alert trigger, a current meeting extender, and a room contention state. The videoconference server transmits the room contention indicator to one or more remote endpoints for display by the one or more remote endpoints.

In another aspect, a graphical user interface is presented for a video conference having a scheduled duration. A videoconference server transmits a video feed to a first endpoint and a second endpoint in the multi-endpoint video conference. The videoconference server furthermore transmits room status information to the first endpoint and the second endpoint to be displayed as with the video feed. The room status information includes, but is not limited to, room schedule information for at least one of the first conference room or the second conference room that indicates that a subsequent conference is scheduled to occur in at least one of the first conference room or the second conference room. In a related aspect, the room status information further includes a first message to the first endpoint that the first endpoint has participants of a subsequent meeting waiting for the first conference room, and a second message to the second endpoint that the first conference room has participants of the subsequent meeting waiting for the first conference room.

### Example Embodiments

People gathering outside a conference room have no good way to communicate with any of the participants inside the room that they are waiting or have a meeting scheduled at that time. Conventionally, people may peek in (if there are windows), knock on the door, or just barge in and interrupt the meeting, but these actions are impolite and awkward. Many are uncomfortable and reluctant to do this, which allows virtual meetings to run over time unchecked.

In addition, even if the participants to the virtual meeting notice people waiting outside, the participants may try to extend the meeting, often without the approval of those waiting outside. For example, a participant to the meeting in the room might say something like “sorry, just two more minutes!” in an effort to extend the meeting, which may or may not be acceptable to the people waiting outside. The subsequent meeting, for instance, may not be one that can be rescheduled or may have a higher priority than the current meeting. If the meeting cannot be extended, the people outside the room have no way of telling the participant(s) in the room this information.

Moreover, the people outside the room have no way to communicate with any remote participants in the meeting. Remote participants are located at endpoints in geographic locations that are remote from the conference room. Accordingly, the remote participants in particular have no way of seeing that people are poking their heads in or knocking on the door to the room. As a result, the remote participants are unaware that there is contention for the conference room and, without that realization, might continue discussion because they don't realize that at least one of the rooms included in the conferencing session cannot go over its allotted time.

Accordingly, there is need for a method and system that allows communication between meeting participants and people waiting outside a conference room to indicate that a room is in contention and/or request a meeting extension. Since virtual meetings easily run over, and can create delays, resolving the social barriers to room contention improves the videoconference experience and allows efficient scheduling/use of videoconference resources.

The present technology is a videoconference system for addressing room contention for a multi-endpoint meeting. The videoconference system can include multiple endpoints across multiple geographic locations, with a videoconference server configured to host a multi-endpoint meeting amongst the multiple endpoints. The multi-endpoint meeting can include at least one local endpoint and at least one remote endpoint, although a multi-endpoint meeting can be any combination of local and remote endpoints. A local endpoint, as the term is used herein, refers to an endpoint in a conference room that has a wallplate of the present technology located outside the conference room; in some embodiments wherein multiple conference rooms have a wallplate located outside, a local endpoint refers to an endpoint in a conference room in which its associated wallplate receives a user input. A remote endpoint, as the term is used herein, either does not have an associated wallplate, or in the specific embodiment in which the remote endpoint is mentioned, the remote endpoint is receiving data that originates from a wallplate at the local endpoint.

The wallplate can be configured to display, among other things, a current status of the multi-endpoint meeting, an in-room alert trigger, current meeting extender, room schedule information, and remote endpoint information. The wallplate can be configured to receive an input from the in-room alert trigger indicating that a room is in contention, and after receiving the received input, send a room contention state indicator to the local endpoint. The local endpoint, in turn, can be configured to receive the room contention state indicator and to send an associated room contention signal to the videoconference server. The videoconference server may be configured to transmit a room contention message to the remote endpoint. The room contention message is an indication that the local endpoint is in a room contention state.

In embodiments, room status information can be used to generate a message on a video feed that people are waiting to use a room. For example, while the meeting is ongoing, the videoconference server may transmit a video feed to the multiple endpoints in the multi-endpoint meeting or video conference. Each of the endpoints can be located in a room that is reserved using a calendaring system. Based on the meetings scheduled with the calendaring system, the videoconference server may transmit room status information to the endpoints to be displayed with the video feed when the video conference has exceeded its scheduled duration. In some embodiments, the room status information can include room schedule information pertaining to a time period subsequent to the scheduled duration, which can be used to inform the local endpoint via a message that the local endpoint has participants of a subsequent meeting that are waiting for the room that includes the local endpoint. Room status information can also be used to further include a message that a remote endpoint has a subsequent meeting currently scheduled in a respective remote conference room, so that all the participants of a meeting can be informed that at least one of the rooms in the virtual meeting is in contention.

The videoconference system described herein allows communication between meeting participants and people outside the room. People who are outside the room can indicate, through a wallplate mounted or located close to the room in contention, that the meeting needs to end. Additionally and/or alternatively, the meeting participants within the room can request the outside people to grant a meeting extension. The user experience around the videoconference system resolves room contention in a convenient and socially acceptable manner, which allows efficient scheduling of videoconference resources.

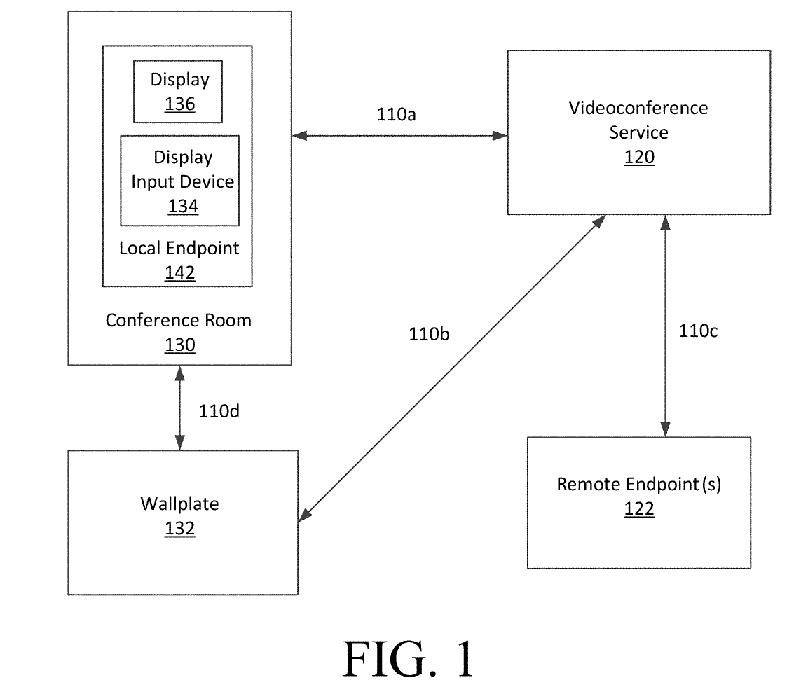

FIG. 1 shows a conceptual block diagram illustrating an example environment for a videoconference system, in accordance with various embodiments of the subject technology. Although FIG. 1 illustrates a client-server network environment, other embodiments of the subject technology may include other configurations including, for example, peer-to-peer environments.

FIG. 1 shows an embodiment in which a server, such as a videoconference service 120 server, is in communication with one or more remote endpoints 122. Each remote endpoint 122 may include one or more remote endpoint devices, and may located at one or more geographic locations. The remote endpoint may be in communication with videoconference service 120. The remote endpoint devices at remote endpoints 122 can be any device in communication with the videoconference service 120, such as a mobile phone, laptop, desktop, tablet, conferencing device installed in a conference room, etc.

The local endpoint 142 can be located within a conference room 130 at a geographic location (e.g., the local endpoint 142 can be a conferencing device installed in the conference room 130, a laptop located within the conference room 130, etc.). The remote endpoint devices 122 can be located in a corresponding conference room at the remote site location(s). However, as will be appreciated by those skilled in the art, in some embodiments the remote endpoint devices 122 do not necessarily need to be in a corresponding conference room.

Local endpoint 142 can be in communication 110a with videoconference service 120. Local endpoint 142 can furthermore be in communication with wallplate 132, either directly 110d via a wired connection, ad hoc network, Bluetooth, or indirectly 110b through videoconference service 120 communicating with local endpoint 142.

Local endpoint 142 can also include a display input device 134 and a display 136 within conference room 130. Display 136 may be a monitor, a television, a projector, a tablet screen, or other visual device that may be used during the meeting. Display input device 134 may be configured to interface with display 136 to provide conferencing session input for display 136. Display input device 134 may be integrated into display 136 or separate from display 136 and communicate with display 136 via a Universal Serial Bus (USB) interface, a High-Definition Multimedia Interface (HDMI) interface, a computer display standard interface (e.g., Video Graphics Array (VGA), Extended Graphics Array (XGA), etc.), a wireless interface (e.g., Wi-Fi, infrared, Bluetooth, etc.), or other input or communication medium.

In some embodiments, the local endpoint 142 can be configured to inform the videoconference service 120 that a participant in the conference room 130 is ready to initiate or join a scheduled meeting. In some embodiments, for example, the display input device 134 may receive input from a participant or other user that they have entered the conference room 130 or are otherwise ready to join a conference meeting. In some embodiments, once the user input has been received, the local endpoint 142 communicates 110a with the videoconference service 120 to inform the videoconference service 120 to begin or join a meeting.

Additionally and/or alternatively, the wallplate 132 outside the conference room 130 can receive user input indicating that they are ready to initiate or join the conference meeting. The wallplate 132 can then communicate 110b with the videoconference service 120 to inform the videoconference service 120 to begin or join a scheduled meeting.

The local endpoint 142 may be configured to coordinate with the other devices in the conference room 130 and videoconference service 120 to start and maintain a conferencing session or meeting. For example, the local endpoint 142 may interact with the display 136 and display input device 134 within the room to facilitate a virtual meeting, either directly or through the videoconference service 120.

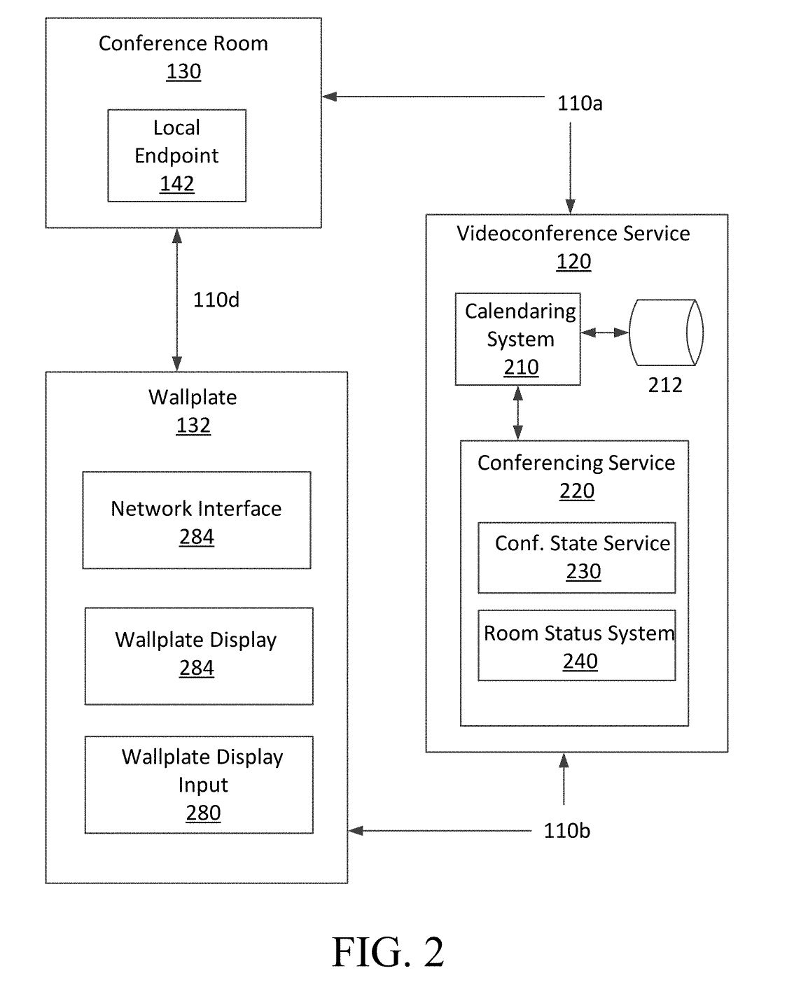

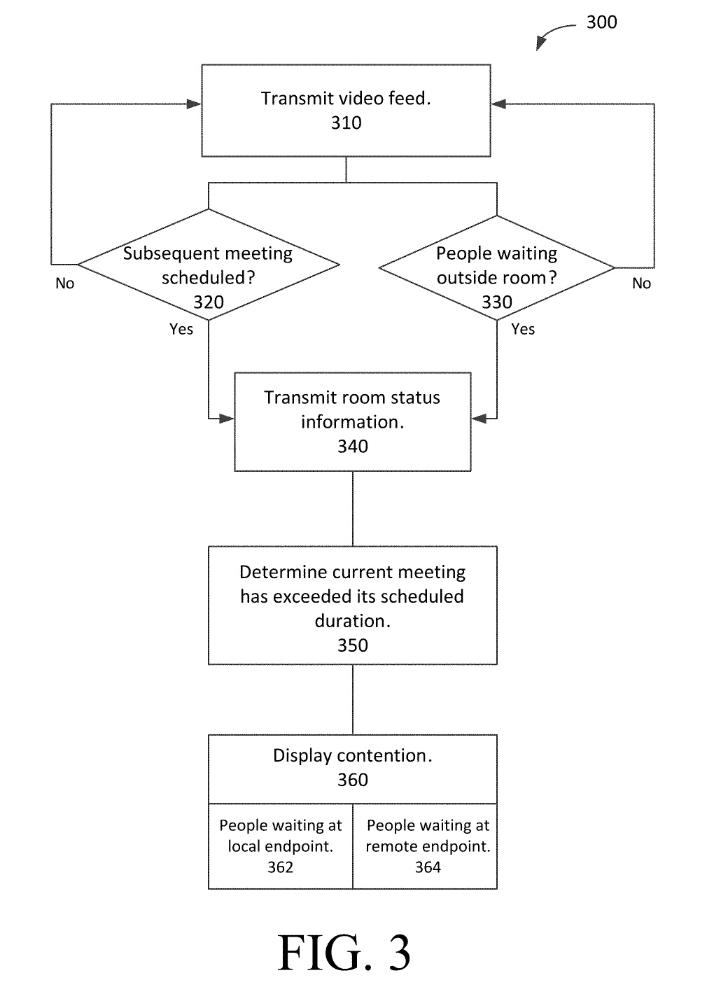

FIG. 2 illustrates a more detailed illustration of a wallplate 132, videoconference server 120, and local endpoint 142 used together in a multi-endpoint meeting interaction, in accordance with various embodiments. The embodiments of FIG. 2 may be used to carry out a method shown in FIG. 3.

Turning to FIG. 2, the videoconference system may include a videoconference service 120, local endpoint 142 within conference room 130, and wallplate 132 according to some embodiments. Videoconference service 120 may be configured to host a multi-endpoint meeting amongst multiple endpoints, including local 142 and remote endpoints. Conference room 130 can be a physical room containing a local endpoint 142.

In some embodiments, a method 300 for resolving room contention for a multi-endpoint meeting can begin when a meeting, or multi-endpoint video conference, is initiated or is in session with active participants at multiple endpoints. For example, a videoconference service 120 on a videoconference server can transmit a video feed to each of the endpoints in the multi-end point video conference (310) after a participant begins or requests to join a meeting.

Each of the endpoints can be located in a room (such as conference room 130) that is reserved using a calendaring system 210. For example, calendaring system 210 can be configured to identify an appropriate meeting to start based on the endpoints participating in the meeting. As will be discussed in further detail below, calendaring system 210 may identify a local endpoint 142 paired with conference room 130 at a particular geographic location. Calendaring system 210 may also access an electronic calendar for local endpoint 142 at the geographic location to determine whether there is a conference meeting or session scheduled for the current time.

If there is a meeting or session scheduled, calendaring system 210 may ask the user if the user wants to join or start the meeting or session as a participant. For example, the calendaring system 210 may instruct the local endpoint 142 to prompt the user to start the meeting or instruct a display input device 134 to prompt the user to start the meeting.

An electronic calendar may include a schedule or series of entries for the participant, local endpoint 142 and remote endpoints, conference room 130, and any other resource associated with a conference meeting. Each entry may signify a meeting or collaboration session and its associated room schedule information, including a date and time (e.g., scheduled start times, scheduled end times, etc.), the number and locations of the endpoints participating in the meeting, duration of the meeting, participating endpoints, identities of the participants, locations, conference rooms, or information relating to any other conference resource. Calendaring system 210 can further include a meeting title or a description of the meeting, which can be input by a user at a device at the local endpoint 142 or wallplate 132.

The electronic calendar on the calendaring system 210 can further include future and past meeting information, which can be stored in scheduling information storage 212. Thus, calendaring system 210 can access the scheduling information storage 212 for room schedule information pertaining to any time period, including time periods subsequent to the scheduled duration in order to determine upcoming multi-endpoint meetings. The room schedule information can include scheduling information for current, upcoming, and past meetings associated with each conference room 130.

A conferencing service 220 may include a processor and computer-readable medium storing instructions that, when executed by conferencing service 220, cause conferencing service 220 to perform various operations for facilitating a virtual multi-endpoint meeting. As discussed above, the videoconference service 120 may prompt the user via the local endpoint 142 or wallplate display 282 to start the meeting or receive a confirmation from the user to start the meeting. Local endpoint 142 then can transmit the confirmation to videoconference service 120, which causes conferencing service 220 to initiate the meeting. In alternative embodiments, conferencing service 220 may initiate the multi-endpoint meeting automatically after the calendaring system 310 identifies an appropriate meeting to start, thereby not requiring the user to input confirmation to start the meeting.

In some embodiments, conferencing service 220 may communicate with calendaring system 210 to room status system 240 to determine room status information pertaining to the conference room 130 associated with local endpoint 142 (e.g., conference room 130 is in use, free, scheduled to start, etc.).

In some embodiments, videoconference service 120 determines if the meeting/video conference has exceeded it scheduled duration (350) using conference state service 230.

The conference state service 230 can, for example, determine the state of the conference. Conference state service 230 can, for example, determine if a current or on-going meeting has exceeded its scheduled duration. In some embodiments, the conference state service 230 can communicate with the calendaring system 210 to check whether the meeting's duration matches an entry in the electronic calendar. Additionally and/or alternatively, the conference state service 230 can communicate with the calendaring system 210 to receive a scheduled end time for the conference. If the conference has moved beyond the scheduled end time, the conference state service 230 can flag the meeting as exceeding its scheduled duration.

The room status system 240 can communicate with calendaring system 210 to determine room status information based on or include room schedule information, including room schedule information pertaining to a time period subsequent to the scheduled meeting. For example, room status system 240 can determine whether conference room 130 is being occupied beyond its scheduled duration based on the conference state service 230 determining that the meeting has exceeded its scheduled duration. The room status system 240 can further communicate with the calendaring system 210 to determine if any meetings have been scheduled during the timeslot or are upcoming. In this way, the endpoints can be notified of upcoming meetings.

The videoconference system may further include a wallplate 132 in communication with the local endpoint 142, videoconference service 120, or both, via one or more networks (e.g., networks 110b, 110d). The wallplate 132 may infuse data about the current status of the meeting in conference room 130, and can be installed right outside conference room 130, such as on a wall next to the door to the room. In some embodiments, wallplate 132 receives videoconference service information from room status system 240 and/or conference state service 230.

Wallplate 132 can display a current status of the multi-endpoint meeting, including scheduling information and information about the endpoints participating in the scheduled meeting. The wallplate 132 can also receive user input from one or more people outside conference room 130 indicating that they are waiting to use the room. Moreover, the wallplate 132 can receive user input that grants an extension of time to the meeting.

In FIG. 2, for example, wallplate 132 may include a network interface 284 that facilitates communication with the videoconference service 120 via network 110b. Additionally and/or alternatively, the network interface 284 can be configured to facilitate communication 110d directly between the wallplate 132 and local endpoint 142.

A wallplate display input 280 may be included on a wallplate display 282, which can receive user input from people waiting outside conference room 130. In some embodiments, wallplate display input 280 is configured to receive an input from an in-room alert trigger that indicates that the room needs to be used for another meeting, putting the room in a room contention state. The room contention state signifies that people are waiting outside the room and wish for the current meeting to end.

A room contention state indicator may be generated from user input that activates the in-room alert trigger. After the the in-room alert trigger has been activated, the wallplate 132 may send the room contention state indicator to the local endpoint 142, either directly or indirectly. For example, the wallplate 132 can send the room contention state indicator to the local endpoint 142 through conference state service 230 of videoconference service 120. The local endpoint 142 can be configured to receive the room contention state indicator, and, based on the room contention state indicator, send a room contention indicator or other similar signal to the videoconference service 120. After receiving the room contention indicator, the videoconference service 120 may then be configured to transmit a room contention message or notification to the remote endpoint 142 indicating that the local endpoint 142 is in a room contention state. The notification may be displayed on a device in the conference room 130 in order to notify the meeting participants that the room is in contention. For example, the notification could be a graphic notification that's part of display 136 that displays information associated with each endpoint in the multi-endpoint meeting, including one or more of whether the physical room is available, is currently scheduled for a meeting, and whether a user has indicated via the wallplate 132 that they are waiting to use the physical room.

The wallplate 132 can display an option to grant an extension of time. The option may be displayed after the room contention notification or message is transmitted, a meeting has begun or is in session, or may be displayed at all times on the wallplate 132. Accordingly, wallplate 132 can receive user input from the wallplate display input 280 that grants an extension of time to the meeting. Once an extension has been granted, the room contention indicator can be overridden for the granted period of time. In some embodiments, the local endpoint 142 and/or one or more of the remote endpoints can override the room contention indicator and extend the meeting for the granted period of time. The period of time can be manually entered or can be a predetermined increment of time (e.g., 5 minutes, 15 minutes, 30 minutes, etc.).

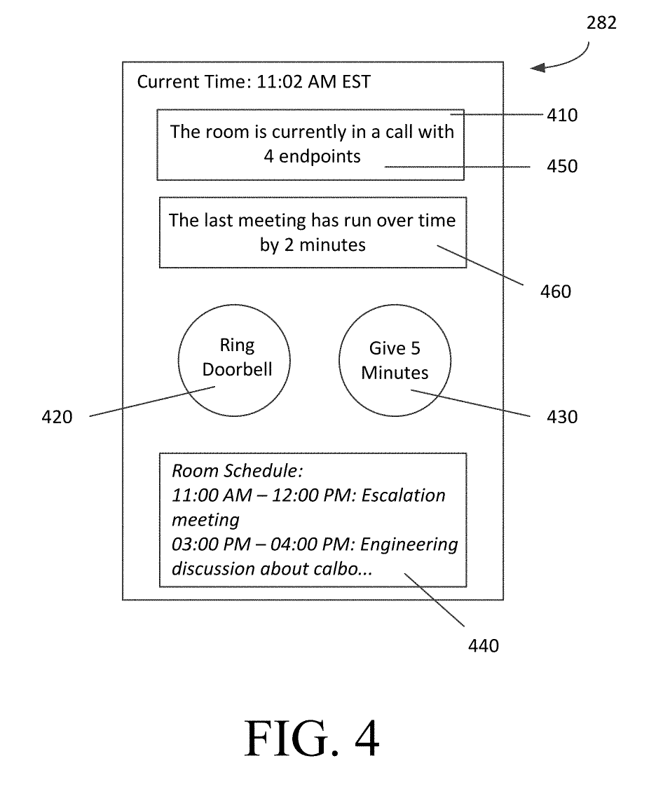

FIG. 4 shows an example of a wallplate display 282. The wallplate 132 may be configured to display an in-room alert trigger 420 and/or current meeting extender 430. The wallplate display 282 can further include a current status 410 of the multi-endpoint meeting, room schedule information 440, and remote endpoint information 450. If the room is in use during a conference and has exceeded its scheduled duration, the displayed current status 410 can include a notification that the room is currently in a call (e.g., “the room is in a call”), or include endpoint information 450 indicating how many endpoints the meeting includes (e.g., “the room is currently in a call with 4 endpoints”). The room schedule information 440 may include the scheduled start time, end time, and/or duration of upcoming meetings, and may further include a meeting title or short description of the subject matter of the upcoming scheduled meetings. The in-room alert trigger 420 may be a button or other area on the wallplate display 382 that a user can push, touch, or otherwise activate to indicate that they are waiting for the room. The in-room alert trigger 420 can, for example, be a doorbell feature that a user can “ring” by touching. The current meeting extender 430 may also be a button that extends the meeting by a period of time, such as granting an extension of 5 minutes.

When the meeting has exceeded its duration, the contention over the room may be displayed at the local endpoint 142 (360). The contention may be displayed as a message, such as a message that the local endpoint 142 has participants of one or more subsequent meetings waiting for the room that includes the local endpoint 142 (362). The contention may additionally and/or alternatively display, at the local endpoint 142, a message that a remote endpoint has a subsequent meeting currently scheduled in a room that includes the remote endpoint (364). Thus, if there is a room contention, the local endpoint 142, any remote endpoints, or both can be notified that people are waiting to begin their meeting.

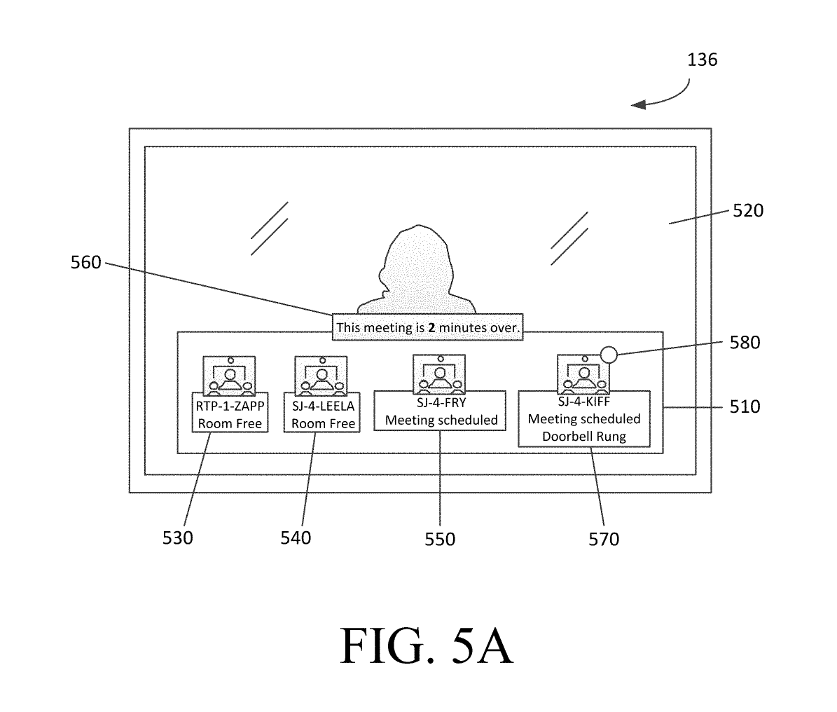

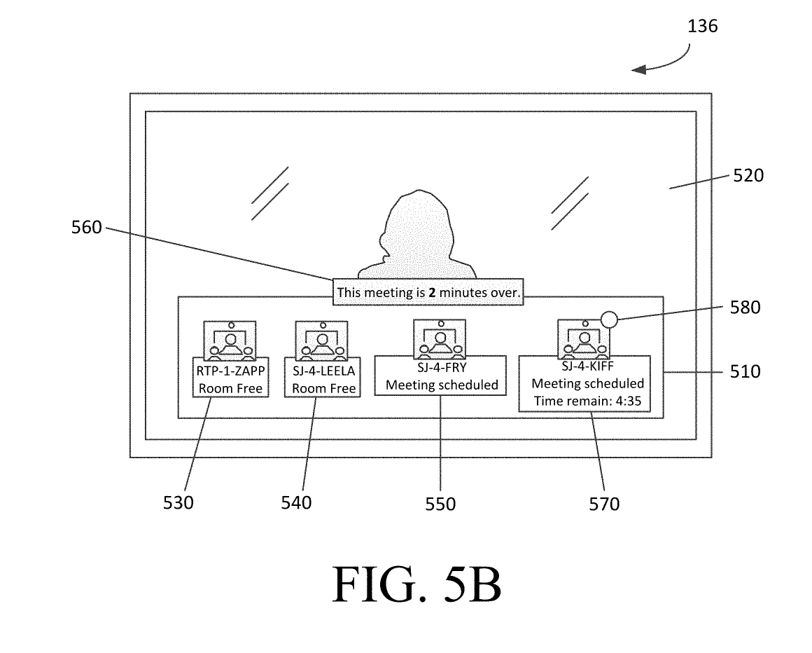

In some embodiments, information from the room status service 240 and/or conference state service 230 can be displayed as an informational display over a video feed (340). FIG. 5A shows just such an example embodiment of a videoconference screen 400 that can be displayed at each of the endpoints. The videoconference screen 500 can include an informational display 510 over a video feed 520. The informational display 510 can include various icons or text that displays room status information and/or conference state information. For example, in the embodiment shown, the informational display 510 can include icons 530, 540 that indicate the conference room 130 is free or is otherwise available. This can be indicated by either text (e.g., “Room Free”), color (e.g., shading the icon in green), or both. The informational display 510 can also include icon 550 that displays that the conference room 130 at that endpoint has a meeting scheduled, either at the current time (e.g., the meeting has exceeded its scheduled duration) or in the near future (e.g., a meeting is scheduled to start in 15 minutes or less and the participants should wrap up). Icon 550 can indicate that a meeting is scheduled in the room by text (e.g., “Meeting Scheduled”), color (e.g., shading the icon in yellow), or both.

Informational display 510 may also display icon 580, which indicates that a room is in contention and there are people waiting outside. Icon 580 can indicate by text (e.g., “doorbell rung”) or color (red or orange) that an in-room alert trigger 420 has been activated by a user outside the room. Room contention may also be displayed as a circle, star, or other marking or shape (colored red or otherwise highlighted) that informs the meeting participants at all endpoints that a room needs to be vacated.

FIG. 5B shows an example videoconference room display when a meeting extension has been granted by those waiting outside through the wallplate 132. Icon 570, for example, may include extension text 590 that indicates how long a participant has until the extended meeting ends. Thus, if an extension of 5 minutes has been granted, icon 580 may display “time remaining: 4:35” after 25 seconds have elapsed.

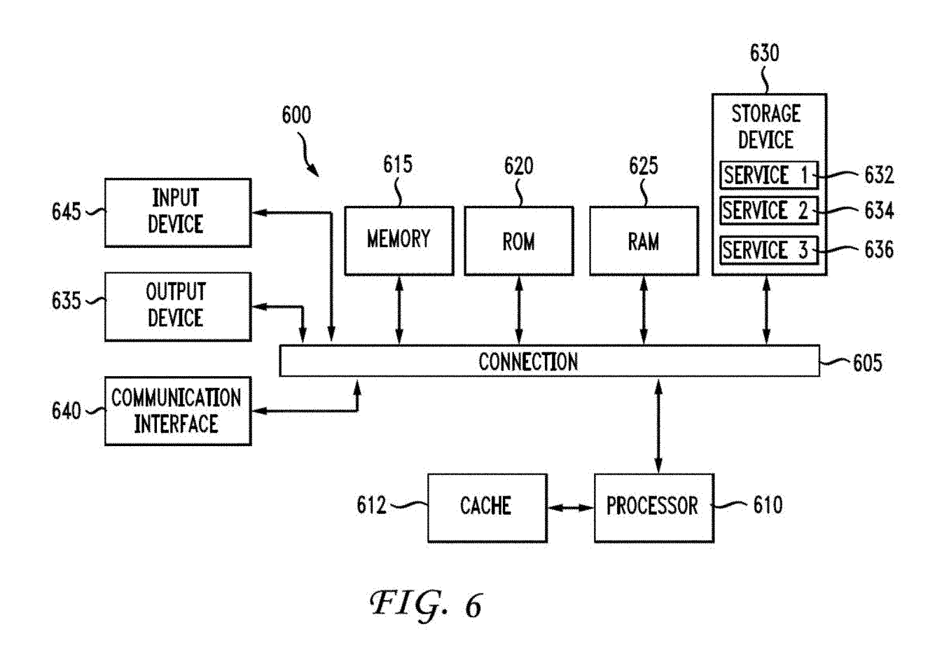

FIG. 6 shows an example of computing system 600 in which the components of the videoconference system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple datacenters, a peer network, etc. In some embodiments, one or more of the described system components represents many such components, each performing some or all of the function for which the component is described. In some embodiments, the components can be physical or virtual devices.

Example system 600 includes at least one processing unit (CPU or processor) 610 and connection 605 that couples various system components, including system memory 615, such as read only memory (ROM) and random access memory (RAM), to processor 610. Computing system 600 can include a cache of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a portable device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A videoconference system for addressing room contention for a multi-endpoint meeting comprising:
a videoconference server configured to host a multi-endpoint meeting amongst a local endpoint and one or more remote endpoints, the videoconference server to;
receive, from a wallplate located outside of a physical room that includes the local endpoint, a room contention indicator indicating a room contention state, wherein the wallplate is configured to display an in-room alert trigger, a current meeting extender, and a room contention state; and
transmit the room contention indicator to one or more remote endpoints for display by the one or more remote endpoints.

2. The videoconference system of claim 1, wherein the notification of the room contention state is a graphic notification that displays information that the videoconference server has received the in-room alert trigger.

3. The videoconference system of claim 1, wherein notification of the room contention state further indicates whether the meeting has extended into a subsequent meeting.

4. The videoconference system of claim 1, wherein the videoconference server is further configured to:
after receiving the in-room alert trigger, receive, from the wallplate, an extension request initiated by the local endpoint; and
receive, from the wallplate, input from the current meeting extender that grants the extension request.

5. The videoconference system of claim 4, wherein the videoconference server extends the multi-endpoint meeting based on receiving the grant of the extension request from the wallplate.

6. The videoconference system of claim 5, wherein granting the extension request enables the videoconference server to transmit a command that enables the local endpoint and the remote endpoints to display an extended time remaining.

7. A method of presenting a graphical user interface for a video conference having a scheduled duration, the method comprising:
transmitting, by a videoconference server, a video feed to a first endpoint in a first conference room and a second endpoint in a second conference room ;
transmitting, by the videoconference server, room status information to the first endpoint and the second endpoint to be displayed with the video feed, the room status information including room schedule information for at least one of the first conference room or the second conference room, the room schedule information indicating that a subsequent conference is scheduled to occur in at least one of the first conference room or the second conference room, the room status information further comprising:
a first message to the first endpoint that the first endpoint has participants of a subsequent meeting waiting for the first conference room; and
a second message to the second endpoint that the first conference room has participants of the subsequent meeting waiting for the first conference room.

8. The method of claim 7, wherein the first message is a graphic notification that displays information that a wallplate communicatively coupled to the first endpoint and located outside of a physical room that includes the first endpoint has received an in-room alert trigger.

9. The method of claim 7, wherein the first message further indicates that the meeting has extended into the subsequent meeting.

10. The method of claim 8, wherein the first message is a notification that displays information that the wallplate communicatively coupled to the first endpoint has received input that grants an extension request.

11. The method of claim 10, wherein the first message is a notification that the multi-endpoint video conference has been extended based on the granted extension request.

12. The method of claim 10, wherein the first message and the second message display an extended time remaining after being granted the extension request.

13. A non-transitory computer-readable medium containing instructions that, when executed by a computing system, cause the computing system to:
transmit, by a videoconference server, a video feed to a first endpoint in a first conference room and a second endpoint in a second conference room ;
transmit, by the videoconference server, room status information to the first endpoint and the second endpoint to be displayed with the video feed, the room status information including room schedule information for at least one of the first conference room or the second conference room, the room schedule information indicating that a subsequent conference is scheduled to occur in at least one of the first conference room or the second conference room, the room status information further comprising:
a first message to the first endpoint that the first endpoint has participants of a subsequent meeting waiting for the first conference room; and
a second message to the second endpoint that the first conference room has participants of the subsequent meeting waiting for the first conference room.

14. The non-transitory computer-readable medium of claim 13, wherein the first message is a graphic notification that displays information that a wallplate communicatively coupled to the first endpoint and located outside of a physical room that includes the first endpoint has received an in-room alert trigger.

15. The non-transitory computer-readable medium of claim 13, wherein the first message further indicates that the meeting has extended into the subsequent meeting.

16. The method of claim 14, wherein the first message is a notification that displays information that the wallplate communicatively coupled to the first endpoint has received input that grants an extension request.

17. The method of claim 16, wherein the first message is a notification that the multi-endpoint video conference has been extended based on the granted extension request.

18. The method of claim 16, wherein the first message and the second message display an extended time remaining after being granted the extension request.
